(19) United States
(12) Patent Application Publication
(10) Pub. No.: US 2020/0226716 A1
(43) Pub. Date: Jul. 16, 2020

(54) NETWORK-BASED IMAGE PROCESSING APPARATUS AND METHOD

(71) Applicant: ELECTRONICS AND TELECOMMUNICATIONS RESEARCH INSTITUTE, Daejeon (KR)

(72) Inventors: Gi Mun UM, Seoul (KR); Hee Kyung LEE, Daejeon (KR); Jeong Il SEO, Daejeon (KR); Joung Il YUN, Daejeon (KR); Seong Yong LIM, Daejeon (KR); Won Sik CHEONG, Daejeon (KR)

(73) Assignee: ELECTRONICS AND TELECOMMUNICATIONS RESEARCH INSTITUTE, Daejeon (KR)

(21) Appl. No.: 16/730,032

(22) Filed: Dec. 30, 2019

(30) Foreign Application Priority Data
Jan. 10, 2019 (KR) 10-2019-0003079
Dec. 11, 2019 (KR) 10-2019-0164568

(51) Int. Cl. G06T 3/40; G06T 5/50; H04N 5/232

(52) U.S. Cl. CPC G06T 3/4038; G06T 2207/20212; H04N 5/23238; G06T 5/50

(57) ABSTRACT

There is provided an image processing apparatus and method. The image processing apparatus comprises: receiving a first source image and a second source image from multiple image sources, receiving geometric information required for stitching the first source image and the second source image and synthesizing an image from the first source image and the second source image on the basis of the geometric information, wherein the geometric information includes seam information used to specify a overlapping region between the first source image and the second source image.

### CROSS REFERENCE TO RELATED APPLICATION

The present application claims priority to Korean Patent Application Nos. 10-2019-0003079, filed Jan. 10, 2019 and 10-2019-0164568, filed Dec. 11, 2019, the entire contents of which is incorporated herein for all purposes by this reference.

### BACKGROUND OF THE INVENTION

### 1. Field of the Invention

The present invention relates to a method and apparatus for processing network-based source images.

### 2. Description of the Related Art

A 360-degree image recording refers to a image recording that can be freely rotated about at least one axis. For example, a 360-degree image recording is free in rotation in terms of at least one of the yaw, roll, and pitch. Since a 360-degree image recording contains a considerably large amount of image information in comparison with a 2D image recording, the file size of a 360-degree image recording is very large. Therefore, it is expected that a image service in which a 360-degree image recording stored in a remote server is played back in a streamed manner is more popular than a image service in which a 360-degree image recording is provided as recorded in a location storage device. Therefore, processing for network-based 360-degree image recordings is being actively discussed.

### SUMMARY OF THE INVENTION

An objective of the present invention is to provide a method in which a media processing apparatus synthesizes a 360-degree image by stitching source images received from multiple image sources.

The present invention provides a detailed structure of metadata for synthesizing a 360-degree image from multiple source images.

Another objective of the present invention is to provide a method and apparatus for identifying an overlapping region in two neighboring source images.

The objectives to be accomplished by the present invention are not limited to those described above, and other objectives and technical problems that are not mentioned above but can be accomplished and addressed by the present invention will be apparent to those skilled in the art from the detailed description given below.

According to one aspect of the present invention, an image processing method includes: receiving a first source image and a second source image from multiple image sources; receiving geometric information required for stitching the first source image and the source image; and synthesizing an image from the first source image and the second source image on the basis of the geometric information. The geometric information may include seam information for specifying the overlapping region in the first source image and the second source image.

In the image processing method according to the present invention, the seam information may include seam point information indicating coordinates of linear lines constituting a boundary seam line of the overlapping region.

In the image processing method according to the present invention, the seam point information may include a start point and an end point of the seam line and a cross point of the linear lines constituting the seam line.

In the image processing method according to the present invention, the seam information may include mask image information for distinguishing the first source image and the second source image from each other.

In the image processing method according to the present invention, the seam information may include seam type information. The seam type information may indicate which of the seam point information and the seam mask information is used to specify the overlapping region.

The features of the present invention which are briefly summarized above are exemplary aspects of embodiments described in the detailed description and are not intended to limit the scope of the present invention.

According to the present invention, a network-based image processing apparatus synthesizes a 360-degree image from source images obtained from multiple image sources.

According to the present invention, the detailed structure of metadata for synthesizing a 360-degree image from multiple source images can be provided.

According to the present invention, there is provided a method of specifying an overlapping region in two neighboring images.

The advantages of the present invention are not limited to the advantages mentioned above, and other advantages that are not mentioned above can be clearly understood by those skilled in the art from the detailed description provided below.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a diagram illustrating an apparatus for network-based media processing;

FIG. 2 is a diagram illustrating a process of synthesizing a 360-degree image from source images and of rendering the 360-degree image;

FIG. 3 is a process of extracting geometric information shown in FIG. 2;

FIG. 4 is an image stitching step shown in FIG. 2;

FIG. 5 is a diagram illustrating a process in which the network-based media processing apparatus performs a geometric information extraction step and an image stitching step on the basis of the extracted geometric information; and

FIG. 6 is an example of specifying an overlapping region in two neighboring images.

### DESCRIPTION OF THE PREFERRED EMBODIMENTS

The present invention may be embodied in many different forms without departing from the spirit and significant characteristics of the invention. Therefore, the embodiments of the present invention are disclosed only for illustrative purposes and should not be construed as limiting the present invention.

It will be understood that, although the terms first, second, etc. may be used herein to describe various elements, these elements should not be limited by these terms.

These terms are only used to distinguish one element, from another element. For instance, a first element discussed below could be termed a second element without departing from the teachings of the present invention. Similarly, the second element could also be termed the first element.

The term “and/or” includes any and all combinations of one or more of the associated listed items.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present.

The terminology used herein is for the purpose of describing particular embodiments only and is not intended to be limiting. As used herein, the singular forms “a,” “an” and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinbelow, exemplary embodiments of the present invention will be described with reference to the accompanying drawings in detail. In addition, like elements are denoted by like reference numerals and a duplicate description thereof will be omitted.

In the present invention, a media processing apparatus refers to a network-based image processing apparatus that receives data related to a 360-degree image recording and processes the received data.

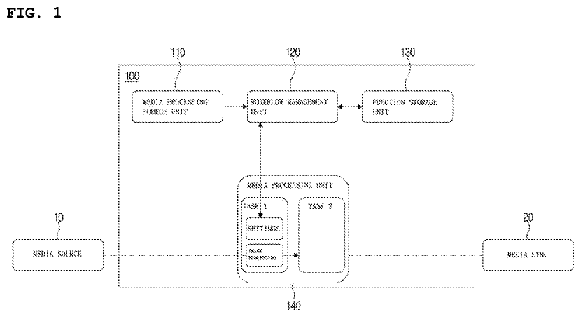

FIG. 1 is diagram illustrating a network-based media processing apparatus. Referring to FIG. 1, a network-based media processing apparatus 100 includes a media processing source unit 110, a workflow management unit 120, a function storage unit 130, and a media processing unit 140.

Blocks illustrated in FIG. 1 are implemented as respective individual devices or as an integrated device. In addition, it is also possible that one block is implemented as multiple devices. The term “device” refers to a computing device capable of performing operations or processing of data, and examples of the device include a controller, a memory, and a wireless or cable communication unit.

The media processing source unit 110 describes a media processing process that is requested and provides information on attributes and formats of media data. Specifically, the media processing source unit 110 provides a workflow description document for the requested media processing to the workflow management unit 120.

The workflow management unit 120 receives the workflow description document from the media processing source unit 110 and creates a workflow for the requested media processing. Specifically, the workflow management unit 120 selects a media processing function according to the workflow description document received from the media processing source unit 110, and instantiate the media processing function as a media processing task. The workflow management unit 120 outputs a workflow that describes metadata related to execution of media processing tasks or a relationship between the media processing tasks.

The function storage unit 130 provides a function description document to the workflow management unit 120 so that the workflow management unit 120 can select an appropriate media processing function.

The workflow management unit 120 outputs a workflow for the requested media processing and notifies the media processing source unit 110 that the workflow has been prepared so that the requested media processing can be started. Specifically, for the network-based media processing, source images are transmitted from the media sources 100 to the media processing unit 140.

The media processing unit 140 performs media processing tasks on source images received from the media source 10 and processes media-related metadata of the source images. The media processing unit 140 constructs, manages, and monitors the media processing tasks. The output of each of the tasks performed by the media processing unit 140 may be used as in input for media sync or the other media processing tasks.

The media processing apparatus 100 performs various processes to generate a 360-degree image. For example, the media processing apparatus 100 receives sources images from the media source 10, defines a stitching-related workflow for the source images, and stitches the source images to synthesize a 360-degree image.

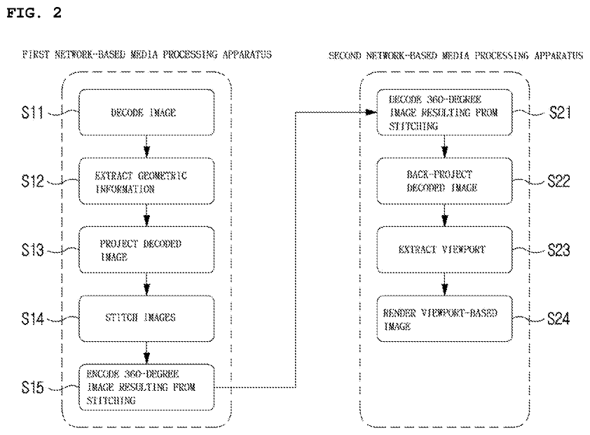

FIG. 2 is a diagram illustrating a process of synthesizing a 360-degree image from source images and rendering the 360-degree image.

A 360-degree image provides viewers a 3-DoF viewing experience. The amount of data of a 360-degree images increases with the resolution of source images. When the amount of data is large, it is difficult for a single server to manage the entire data of a 360-degree image. In order to solve this problem, a plurality of servers or media sources manages source images before an image stitching process to produce a 360-degree image is performed, and a cloud device stitches the source images to synthesize a 360-degree image. According to this technique, instead of a single server managing the entire data of a 360-degree image, multiple servers or media sources manage the data of a 360-degree image in a distributed manner. For example, the media sources may be multiple cameras to generate source images used to generate a 360-degree image.

Referring to FIG. 2, the network-based media processing process for synthesizing and rending a 360-degree image can be divided into a 360-degree image synthesis process and a 360-degree image rendering process. The 360-degree image synthesis process is performed by a first network-based media processing apparatus (that is, a first cloud device) that is responsible for image stitching, and the 360-degree image rendering process is performed by a second network-based image processing apparatus (that is, a second cloud device) responsible for viewport-dependent image rendering.

The 360-degree image synthesis process includes a decoding step (or task) S11, a geometric information extraction step (or task) S12, a projection step (or task) S13, an image stitching step (or task) S14, and an encoding step (or task) S15. A 360-degree image is generated from a plurality of source images through the 360-degree image synthesis process, and a bitstream of the generated 360-degree image is then generated.

Through the decoding step (or task) S11, a plurality of source images received from a plurality of servers or media sources is decoded S11. Specifically, when encoded raw images are input from the multiple media servers or the multiple media sources, the image type of each of the input raw images is converted through decoding.

Through the geometric information extraction step (or task) S12, geometric information on the source images received from the multiple servers or the multiple media sources is extracted. The geometric information includes at least one type of information among feature points, a correlation between the feature points, intrinsic parameters of each camera, extrinsic parameters of each camera, depth information, and seam information. The extracted geometric information is used for alignment of the source images, lens distortion compensation, or frame packing of the source images.

Through the projection step (or task) S13, the frame packing of the decoded source images is performed on the basis of extracted position information. The frame packing is performed in accordance with a projection format, and examples of the projection format includes equirectangular projection, cube map, icosahedron projection (ISP), octahedron projection (OHP), and sphere segmented projection (SSP).

Through the image stitching step (or task) S14, a plurality of source images is stitched to synthesize a 360-degree image on the basis of the extracted geometric information.

Through the encoding step (or task) S15, the synthesized 360-degree image is encoded, and the bitstream of the 360-degree image is generated through encoding.

The 360-degree image rendering process includes a decoding step (or task) S21, a back-projection step (or task) S22, a viewport extraction step (or task) S23, and a image rendering step (or task) S24. Through the 360-degree image rendering process, a 360-degree image is decoded, and a portion corresponding to the viewport of the decoded image is rendered.

Through the decoding step (or task) S21, a 360-degree image synthesized from a plurality of source images is decoded.

Through the back-projection step (or task) S22, a decoded 360-degree image having a geometric shape according to the projection format is developed on a 2D plane. For the back-projection, information on the projection format of the 360-degree image is signaled.

Through the viewport extraction step (or task) S23, the position of the viewport which is a viewing portion shown to the viewer is extracted according to the movement of the viewer (i.e., movement of a head mount display (HMD)) who views the 360-degree image. In this step (or task), a region of interest according to the viewing direction of the viewer is extracted.

Through the image rendering step (or task) S24, an area corresponding to the extracted viewport of the 360-degree image is determined, and the determined area is rendered on the HMD.

In the above example, the projection step and the back-projection step are optional. Therefore, the steps can be omitted depending on the type of the input image.

Table 1 shows input and output data at each step or task.

TABLE 1

| Task | Input | Output |
|---|---|---|
| Decoding | Data of encoded | Data of decoded source |
| | source images input | images |
| | from media sources | |
| Extraction | Data of decoded | Geometric information |
| of geometric | source images | on source images |
| information | | |
| Projection | Source images to be | Projected 360-degree |
| | stitched | image |
| Stitching of | Data and geometric | 360-degree image |
| images | information of source | resulting from stitching |
| | images to be stitched | |
| Encoding | Projected 360-degree | Projected and encoded |
| | image | 360-degree image |
| Back- | Aligned 360-degree | Back-projected 360- |
| projection | image (360-degree | degree image(360- |
| | image resulting from | degree image developed |
| | stitching) | on 2D plane) |
| Extraction | Viewing direction of | Extracted viewport area |
| of viewports | viewer | (area of interest) and |
| | | rendered viewport image |
| Image | Position information | Rendered 360-degree |
| rendering | on viewport, and 360- | image according to |
| | degree image resulting | extracted viewport |
| | from stitching | |

In order to synthesize a 360-degree image from a plurality of source images, the extraction of geometric information on the plurality of source images needs to be performed through the geometric information extraction task or step. The extracted geometric information is used for at least one processing operation among lens distortion compensation for projection and image stitching, image alignment based on camera parameters, blending, and post-processing.

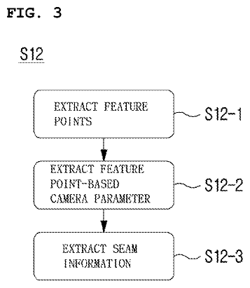

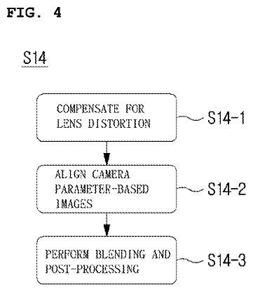

FIG. 3 illustrates the geometric information extraction step shown in FIG. 2 in detail, and FIG. 4 illustrates the image stitching step shown in FIG. 2 in detail.

The geometric information extraction step (or task) S12 includes at least one step (or task) among a step (or task) S12-1 of extracting feature points, a step (or task) S12-2 of extracting camera parameters according to the feature points, and a step (or task) S12-3 of extracting seam information.

In the feature point extraction step (or task) S12-1, feature points of two neighboring source images are extracted. The feature points are used to identify an overlapping region in two neighboring source images and to align the positions of two neighboring source images.

In the camera parameter extraction step (or task) S12-2 based on the feature points, corresponding areas (i.e., overlapping region) in the two neighboring source images are determined on the basis of the extracted feature points. In this step (or task), intrinsic and extrinsic parameters of cameras are extracted. At least either the intrinsic parameters or the extrinsic parameters of the cameras include a nomography matrix for image alignment.

In the seam information extraction step (or task) S12-3, when an object suddenly appears in front, seam information is newly extracted or the previously extracted seam information is updated. Specifically, in this step (or task), when information that a new object appears when two source images are compared is input, new seam information is extracted or the initial (previous) extracted seam information is updated. Table 2 is a chart showing the input and output of each step.

TABLE 2

| Task | Input | Output |
|---|---|---|
| Extraction | Source images | Features of source images |
| of features | | |
| Extraction | Features of source | Relationship between |
| of feature- | images | extracted features, and |
| based | | camera intrinsic/extrinsic |
| camera | | parameters |
| parameter | | |
| Extraction | (initial(previous) | Seam information (updated |
| of seam | extracted seam | seam information |
| information | information), | |
| | object occurrence | |
| | information, and | |
| | source images | |

The image stitching step (or task) S14 using the geometric information includes at least one step (or task) among a lens distortion compensation step (or task) S14-1, an image alignment step (or task) S14-2 based on camera parameters, and a blending and post-processing step (or task) S14-3.

In the lens distortion compensation step (or task) S14-1, an image distortion correction is performed on the basis of lens distortion parameters.

In the image alignment step (or task) S14-2 based on the camera parameters, the geometric alignment is performed on two source images on the basis of nomography calculated during a camera calibration process.

In the blending and post-processing step (or task) S14-3, filtering for color difference correction and noise removal for the overlapping region in the aligned two source images is performed.

Table 3 is a chart showing inputs and outputs in respective three steps.

TABLE 3

| Task | Input | Output |
|---|---|---|
| Compensation | Data of distorted image | Data of distortion- |
| of lens distortion | | compensated image |
| Camera | Source images and | Geometrically aligned |
| parameter- | camera intrinsic/ | 360-degree image |
| based image | extrinsic parameters | |
| alignment | | |
| Blending and | Geometrically aligned | 360-degree image |
| post-processing | 360-degree image | resulting from blending |
| | | and post-processing |
| | | (360-degree image |
| | | resulting from stitching) |

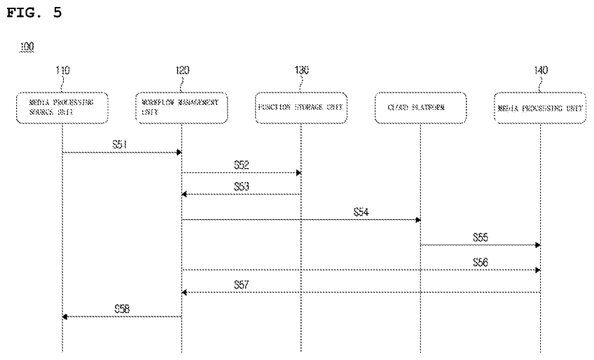

FIG. 5 is a diagram illustrating a geometric information extraction step and an image stitching step using the extracted geometric information, which are performed in a network-based media processing apparatus.

In step S51, the media processing source unit generates a workflow description document for image stitching, and transmits the generated workflow description document to the workflow management unit. The workflow management unit generates a workflow for image stitching on the basis of the received workflow description document. The workflow includes at least one descriptor among an input descriptor, a processing descriptor, a requirement descriptor, an output descriptor, a failover descriptor, or a monitoring descriptor.

The input descriptor provides information on at least one of the number of source images, the codec type of the source images, the frame rate of the source images, and the resolution of the source images. The processing descriptor provides information on the details of the image processing task of performing image stitching. The requirement descriptor provides information on the requirements, for example, delay requirements required to perform a complete task. The output descriptor provides information on data (for example, 360-degree image generated through stitching) to be output through the workflow. The failover descriptor provides information on a failure mode execution in the event of a workflow failure. The monitoring descriptor provides information (for example, critical event) on monitoring of the workflow.

In step (or task) S52, in order to create a workflow, the workflow management unit requests the function storage unit to search for the image stitching-related functions to be employed.

In step (or task) S53, with respect to the request of the workflow management unit, the function storage unit provides a list of potential functions that are expected to be related to the workflow creation.

The workflow management unit selects functions to be used for image stitching from the list of potential functions, and requests a cloud platform to create a media processing unit and to call the selected functions for the media processing unit.

In step (or task) S55, the cloud platform checks the network access information of the workflow management unit and the creation of the media processing unit.

In step (or task) S56, the workflow management unit generates a configuration for each task for image stitching and applies the generated configuration to a corresponding task.

In step (or task) S57, when the settings are applied to the task, access information is returned so that the workflow management unit can perform the next task.

In step (or task) S58, when the settings are applied to all the tasks, the workflow management unit informs the media processing source unit that the media processing related to workflow creation and image stitching can be started.

When media processing for image stitching begins, the workflow management unit continuously monitors metadata (i.e., content-dependent metadata) associated with the output of each task. When the parameters for the next segment have changed, the workflow management applies the updated settings to the next task.

When image stitching is no longer needed (that is, there is no request for a stream for image stitching), the media processing source unit or the media source terminates the image stitching-related workflow.

As in the above example, geometric information on source images is required for image stitching, and the geometric information includes seam information. The present invention proposes a metadata format related to seam information used for image stitching.

The seam information includes at least one type of information among seam point information, seam mask information, seam type information, and coordinate type information. Hereinafter, each type of information constituting the seam information will be described in detail.

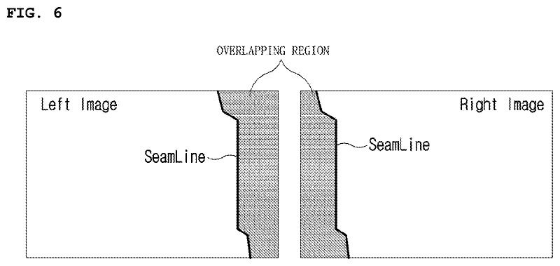

FIG. 6 is a diagram illustrating an example of specifying an overlapping region in two neighboring images.

A seam line represents the boundary of an overlapping region in the two neighboring images. The seam line consists of at least one linear line or at least one curve, depending on a parallax minimization policy.

In the example shown in FIG. 6, the seam line consists of a plurality of linear lines. In this example, the overlapping region is specified on the basis of the coordinate information of the plurality of linear lines. Specifically, the overlapping region may be specified on the basis of position information including a start point and an end point of each linear line and a cross point of the linear lines constituting the seam line. The position information of a plurality of linear lines specifying the overlapping region is defined as the shim point information.

The seam point information includes at least either seam coordinate information or channel count information. The seam coordinate information means the coordinates of the linear lines (that is, the coordinates of a start point, an end point, and a cross point of each linear line) constituting the seam line for specifying the overlapping region. The channel count information means the number of input channels to which the seam point information is input.

Alternatively, the seam line is defined on the basis of a mask image. The mask image shows an overlapping region between the two images. The information on the mask image for specifying the overlapping region is defined as the seam mask information.

The mask image is a black-and-white image consisting of 0's and 1's. For example, the value of each of the pixels constituting the overlapping region is set to 1 (or 0), and the value of each of the pixels constituting the other regions is set to 0 (or 1).

The seam mask information is used to specify an overlapping region in two neighboring images.

The seam mask information includes at least one type of information among mask image information, channel count information, and channel information. The mask image information includes information on the configuration of the mask image (that is, information on pixel values of the mask image) or path information of the mask image. Here, the path information of the mask image indicates a storage path of the mask image composed of black and white pixels, which is used to specify an overlapping region between two neighboring images. The storage path is expressed in the form of a uniform resource identifier (URI) address. The channel count information indicates the number of input channels to which the path information on the mask image is input. The channel information specifies the channel to which the mask image is applied. The two neighboring source images are specified by the channel information.

The seam type information indicates which of the seam point information and the seam mask information defines the overlapping region. For example, when the seam type information is “seam point”, the seam point information is used to specify an overlapping region between source images constituting a 360-degree image. On the other hand, when the seam type information is “seam mask”, the seam mask information is used to specify an overlapping region between source images constituting a 360-degree image.

The coordinate type information indicates a coordinate system of points constituting the seam line defining an overlapping region between two neighboring source images. The coordinate type information includes at least one type of information among left (or top) channel information, right (or bottom) channel information, and coordinate system setting information. The left (or top) channel information indicates a channel allocated to the left (or top) source image of the two neighboring images. The right (or bottom) channel count information indicates the number of channels allocated to the right (or bottom) source image of the two neighboring images. The coordinate system setting information indicates which of the two neighboring source images the coordinates of the linear lines constituting the seam line belong to. For example, when the seam line is determined according to the coordinate system of the left or top image among the two neighboring source images, the coordinate system setting information is set to a first value. On the other hand, when the seam line is determined according to the coordinate system of the right or bottom image among the two neighboring source images, the coordinate system setting information is set to a second value different from the first value. For example, two different values selected from among 0, 1, and 2 are set to the first value and the second value, respectively.

Table 4 shows a syntax table of seam information.

TABLE 4
<!-- ###################################################### -->

| | | | | |
|---|---|---|---|---|
| <!-- | Definition | of | SeamInformation | DataType |

-->
<!-- ###################################################### -->

| <complexType name=“CoordsType”> | | |
|---|---|---|
| <simpleContent> | | |
| <extension base=“mpeg7:IntegerMatrixType”> | | |
| <attribute | name=“leftCh” | type=“unsignedShort” |

use=“required”/>

| | | |
|---|---|---|
| <attribute | name=“rightCh” | type=“unsignedShort” |

use=“required”/>

| | | |
|---|---|---|
| <attribute | name=“side” | type=“unsignedShort” |

use=“required”/>

| </extension> | | |
|---|---|---|
| </simpleContent> | | |
| </complexType> | | |
| <complexType name=“SeamPointsType”> | | |
| <sequence> | | |
| <element | name=“SeamCoords” | type=“nbmp:CoordsType” |

minOccurs=“0” maxOccurs=“unbounded”/>

| </sequence> | |
|---|---|
| <attribute name=“numberOfChannels” | type=“unsignedShort” |

use=“required”/>

| </complexType> | | |
|---|---|---|
| <complexType name=“MaskType”> | | |
| <attribute name=“maskimage” type=“anyURI” use=“required”/> | | |
| <attribute name=“ch” type=“unsignedShort” use=“required”/> | | |
| </complexType> | | |
| <complexType name=“SeamMasksType”> | | |
| <sequence> | | |
| <element | name=“SeamMask” | type=“nbmp:MaskType” |

minOccurs=“0” maxOccurs=“unbounded”/>

| </sequence> | |
|---|---|
| <attribute name=“numberOfChannels” | type=“unsignedShort” |

use=“required”/>

| </complexType> | |
|---|---|
| <complexType name=“SeamInformationType”> | |
| <sequence> | |
| <choice maxOccurs=“unbounded”> | |
| <element name=“SeamPoints” type=“nbmp:SeamPointsType”/> | |
| <element name=“SeamMasks” type=“nbmp:SeamMasksType”/> | |
| </choice> | |
| </sequence> | |
| </complexType> | |
| <element | name=“SeamInformation” |

type=“nbmp:SeamInformationType”/>

In the example of Table 4, “CoordsType” represents the coordinate type information. Attributes “leftCh”, “rightCh”, and “side” included in the coordinate type information represent information on the number of left (or top) channels, information on the number of right (or bottom) channels, and information on the settings of a coordinate system, respectively.

“SeamPointsType” represents the seam point information. “SeamCoords” and “numberOfChannels” included in the seam point information respectively represent the seam coordinate information and the channel count information. “SeamCoords” is configured by continuously arranging the coordinates of multiple linear lines constituting the seam line.

“SeamMaskType” represents the seam mask information. The number of channels is represented by “numberOfChannels”. “SeamMask” calls “MaskType”. The path information and the channel information are indicated by the MaskType. For example, “maskimage” and “ch” included in the MaskType respectively represent the path information and the channel information.

“SeamInformationType” represents the seam type information. In connection with the seam type information, either “SeamPoints” or “SeamMasks” is selected. “SeamPoints” means that the element defining an overlapping region is the seam point information, and “SeamMasks” means that the element defining an overlapping region is the seam mask information.

As in the example of Table 4, the seam information “SeamInformation” includes at least one of the seam coordinate information “CoordsType”, the seam point information “SeamPointsType”, the seam mask information “SeamMaskType”, and the seam type information “SeamInformationType”.

Next, an embodiment of specifying an overlapping region using seam information will be described in detail.

Table 5 shows an example of using seam point information.

TABLE 5

<SeamInformation>
<SeamPointsnumberOfChannels=”3”>
<SeamCoords mpeg7:dim=″2 3″ leftCh =”1”, rightCh =”2” side

=”1”> 280 0 300 100 310 200</SeamCoords>

<SeamCoords mpeg7:dim=″2 3″ leftCh =”1”, rightCh =”2” side

=”2”> 80 0 100 100 110 200</SeamCoords>

<SeamCoords mpeg7:dim=″2 4″ leftCh =”2”, rightCh =”3” side

=”1”> 240 0 270 50 300 100 310 200</SeamCoords>

<SeamCoords mpeg7:dim=″2 4″ leftCh =”2”, rightCh =”3” side

=”2”> 40 0 70 50 100 100 110 200</SeamCoords>

<SeamCoords mpeg7:dim=″2 3″ leftCh =”3”, rightCh =”4” side

=”1”> 230 0 300 100 310 200</SeamCoords>

<SeamCoords mpeg7:dim=″2 3″ leftCh =”3”, rightCh =”4” side

=”2”> 30 0 100 100 110 200</SeamCoords>

</SeamPoints>
</SeamInformation>

In the example of Table 5, “<numberOfChannels=3>” represents that the seam point information is input to a total of three input channels. In the case of a first channel, a overlapping region between a source image leftCh=1 and a source image rightCh=2 is defined by the seam line. Specifically, the overlapping region in a left image (side=1) is defined by the seam line made up of linear lines passing the positions (280, 0), (300, 100), and (310, 200), and the overlapping region in a right image (side=2) is defined by the seam line made up of linear lines passing the positions (80, 0), (100, 100), and (110, 200). Here, (x, y) represents an x-axis coordinate and a y-axis coordinate.

In the case of a second channel, a overlapping region between a source image leftCh=2 and a source image rightCh=3 is defined by the seam line. Specifically, the overlapping region in a left image (side=1) is defined by the seam line made up of linear lines passing the positions (240, 0), (270, 50), (300, 100), and (310, 200), and the overlapping region in a right image (side=2) is defined by the seam line made up of linear lines passing the positions (40, 0), (70, 50), (100, 100), and (110, 200).

In the case of a third channel, a overlapping region between a source image leftCh=3 and a source image rightCh=1 is defined by the seam line. Specifically, the overlapping region in a left image (side=1) is defined by the seam line made up of linear lines passing the positions (230, 0), (300, 100), and (310, 200) and the overlapping region in a right image (side=2) is defined by the seam line made up of linear lines passing the positions (30, 0), (100, 100), and (110, 200).

Table 6 shows an example of using seam mask information.

TABLE 6

| <SeamInformation> | | |
|---|---|---|
| <SeamMasksnumberOfChannels=“5”> | | |
| <SeamMaskmaskimage=“ | http://server/mask_ch01.png” | ch |

=“1”/>

| | | |
|---|---|---|
| <SeamMaskmaskimage=“ | http://server/mask_ch02.png” | ch |

=“2”/>

| | | |
|---|---|---|
| <SeamMaskmaskimage=“ | http://server/mask_ch03.png” | ch |

=“3”/>

| | | |
|---|---|---|
| <SeamMaskmaskimage=“ | http://server/mask_ch04.png” | ch |

=“4”/>

| | | |
|---|---|---|
| <SeamMaskmaskimage=“ | http://server/mask_ch05.png” | ch |

=“5”/>

</SeamMasks>
</SeamInformation>

In the example of Table 6, “<SeamMasksnumberOfChannels=“5”>” indicates that the seam mask information is input to a total of three input channels. In the example of Table 6, a mask image stored in a storage path of http://server/mask_ch0N.png is used for an N-th channel (ch=N, where N is a natural number ranging from 1 to 5).

The above embodiment is described according to the order of steps in a flowchart. However, the method is not limited to the time-series order of the steps. The steps may be performed concurrently or in a different order. In the embodiment described above, constitutional elements (for example, units, modules, etc.) of each block diagram are implemented as respective hardware or software pieces, or multiple constitutional elements may be implemented as an integrated hardware or software piece. The embodiment described above may be implemented in the form of programming instructions that can be executed by various computing elements and recorded on a computer-readable recording medium. The computer-readable recording medium may contain programming instructions, data files, data structures, solely or in combination. Examples of the computer-reading recording medium include: magnetic media such as a hard disk, a floppy disk, and a magnetic tape; optical recording media such as a CD-ROM and a DVD; magneto-optical media such as a floptical disk; and dedicated hardware devices configured to store and execute programming instructions, for example, ROM, RAM, and flash memory. The hardware device can be configured as one or more software modules for performing processing according to the present invention and vice versa.

What is claimed is:

1. An image processing apparatus comprising:
receiving a first source image and a second source image from multiple image sources;
receiving geometric information required for stitching the first source image and the second source image; and
synthesizing an image from the first source image and the second source image on the basis of the geometric information,
wherein the geometric information includes seam information used to specify a overlapping region between the first source image and the second source image.

2. The image processing apparatus according to claim 1, wherein the seam information includes seam point information indicating coordinates of linear lines constituting a seam line that is a boundary of the overlapping region.

3. The image processing apparatus according to claim 2, wherein the seam point information includes a start point of the seam line, an end point of the seam line, and a cross point of the linear lines constituting the seam line.

4. The image processing apparatus according to claim 1, wherein the seam information includes mask image information for distinguishing the first source image and the second source image from each other.

5. The image processing apparatus according to claim 1, wherein the seam information includes seam type information, and wherein the seam type information indicates which of the seam point information and the seam type information is used to specify the overlapping region.

6. An image processing apparatus comprising:
a media processing source unit requesting creation of a workflow for processing image stitching;
a workflow management unit creating the workflow including an image stitching task in response to the request issued by the media processing source unit; and
a media processing unit receiving a first source image and a second source image from multiple image sources and performs an image stitching task included in the workflow on the basis of metadata for the image stitching,
wherein the metadata includes geometric information of the first source image and the second source image, and
wherein the geometric information includes seam information for specifying a overlapping region between the first source image and the second source image.

7. The image processing apparatus according to claim 6, wherein the seam information includes seam point information indicating coordinates of linear lines constituting a seam line that is a boundary of the overlapping region.

8. The image processing apparatus according to claim 7, wherein the seam point information includes a start point of each of the seam line, an end point of the seam line, and a cross point of the linear lines constituting the seam line.

9. The image processing apparatus according to claim 6, wherein the seam information includes mask image information for distinguishing the first source image and the second source image from each other.

10. The image processing apparatus according to claim 6, wherein the seam information includes seam type information, and wherein the seam type information indicates which of the seam point information and the seam mask information is used to specify the overlapping region.
